(19) United States
(12) Patent Application Publication
(10) Pub. No.: US 2007/0087166 A1
(43) Pub. Date: Apr. 19, 2007

(54) Cool roof covering and adhesive therefor

(76) Inventors: Richard Lee, North Canton, OH (US); Ge Wang, Solon, OH (US); Gregory Rudolph, Chagrin Falls, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/250,075

(22) Filed: Oct. 13, 2005

(51) Int. Cl. B32B 27/04; C09J 125/04; B32B 37/00

(52) U.S. Cl. 428/143; 156/327

(57) ABSTRACT

A cool roof covering for protecting a roof substrate comprises an adhesive layer and a layer of aggregate at least partially embedded in the adhesive layer, the cool roof covering exhibiting a solar reflectance of at least 70% and a thermal emittance of at least 75%, the adhesive layer being formed from a VOC-compliant organic solvent-based sprayable adhesive.

### BACKGROUND AND SUMMARY

This disclosure relates to a new “cool roof” covering, i.e. a roofing system having high solar reflectance and high heat emittance. See, for example, Published Application US 2004/0244316 for a Cool Roof Covering, the disclosure of which is incorporated herein by reference. In addition, this disclosure relates to a new adhesive for use in making such a roofing system.

In accordance this disclosure, a new cool roof covering for protecting a roof substrate comprises an adhesive layer and a layer of aggregate at least partially embedded in the adhesive layer, the cool roof covering exhibiting a solar reflectance of 70-90% and a thermal emittance of 75-95%, the adhesive layer being formed from a VOC-compliant organic solvent-based sprayable adhesive.

In addition, this disclosure also provides a new adhesive for use in making such a roofing system, the adhesive comprising a storage-stable, VOC-compliant, sprayable mixture containing one or more weather-resistant organic resins, an organic solvent system capable of dissolving the organic resins and a light weight filler present in sufficient amount so that the adhesive has a density of 6 lbs./gal. or less.

### DETAILED DESCRIPTION

The new cool roof covering of this disclosure comprises an adhesive layer and a layer of aggregate at least partially embedded in the adhesive layer. It exhibits a solar reflectance of 70-90%, as measured by ASTM E1918-97 and ASTM E903-96, and a thermal emittance of at least 75-95, as measured by ASTM E-408-71.

Roof Substrate

The new cool roof covering of this disclosure is particularly useful for covering low-slope bituminous roof substrates, i.e. low-slope roof substrates whose outer layer (i.e. the layer to be contacted with the cool roof system) are made from a bituminous material, or a carrier such as paper, fiberglass, polyester or felt impregnated with a bituminous material, or other similar materials. In this context, “low slope” means a substantially horizontal roof surface sloped enough to allow positive drainage. Low slope BUR (built up roof) or MB (Modified Bitumen) roofing systems, i.e., roofing systems composed of multiple layers of bituminous coated membranes adhered to form a monolithic membrane upon fully curing, are especially interesting.

Where the outer layer of the roof substrate is made from another material such as wood, concrete, metal or plastic, for example, it can be cleaned of dirt and other impurities and/or pretreated by well-known activation techniques for enhancing its surface adhesion properties.

The Aggregate

A wide variety of different aggregates are commonly used for making conventional asphalt/aggregate, layered roofing systems, i.e., roofing systems for low-slope roofs in which a layer of aggregate is at least partially embedded in a previously applied layer of tar, asphalt or other bituminous material. Examples include but are not limited to gravel, limestone, granite, slag, volcanic rock, crushed brick, dolomite, tabular alumina, ceramic and marble. As appreciated by those skilled in this field, such aggregates can have a fairly wide range of average particle sizes normally ranging from as low as ¼ inch to as large as 2 inches. More typically, however, such aggregates will have average particle sizes of about ¼ inch to 1 inch, or even ⅜ inch to ¾ inch. Number 11 granules are especially interesting.

Theoretically, any such aggregate can be used in making the new cool roof covering of this disclosure. However, because the solar reflectance and thermal emittance properties of the cool roof covering ultimately produced are determined in large part by this material, the aggregate used in particular embodiments should be selected achieve the solar reflectance and thermal emittance properties desired.

Thus, aggregates which are lighter in color are preferable to darker aggregates, since lighter materials absorb less infrared radiation. Thus, aggregates such as mica, marble chips, granite, limestone, etc. are more desirable, as they absorb and retain less heat than others. Similarly, aggregates having Mohl hardness of greater than 4 are preferable, as are aggregates which resist crumbling in use.

The Adhesive

The adhesive used in making the new cool roof covering of this disclosure comprises a VOC-compliant, mixture containing one or more organic resins, an organic solvent system capable of dissolving the organic resins and a light weight filler present in sufficient amount so that the adhesive has a density of 6 lbs./gal. or less. Particularly interesting adhesives have densities of about 5 lbs/gal or less. In a particular embodiments, this mixture may also be storage stable, fire retardant or both. Desirably, the mixture is also sprayable.

In this context, “VOC-compliant” means that the composition contains no more than 250 grams of non-exempt volatile organic compounds per liter of composition. Compositions containing no more than 225 gms/l VOC's, or no more than 200 gms/l VOC's and even no more than 175 gms/l VOC's, are particularly interesting.

Similarly, “sprayable” in this context means that the mixture can be applied to a roof substrate by means of commercially-available spraying equipment, for example, a double ball displacement pump with a pressure range of 700 to 500 psi such as Hennis-Johnson HJ4518X, HJ5318, or a Garlock 120 Sprayer. As appreciated by those skilled in the art, sprayable mixtures have viscosities and other properties which allow them to be atomized into droplets by the shear forces created when the composition is forced through a nozzle at high pressure while simultaneously allowing the droplets so-created to recombine into a coherent mass in layer form when deposited on a substrate.

Also, “storage stable” means that the composition can be stored in containers for at least six months without substantial separation of its light weight filler whereby only minor mixing is necessary to provide a homogenous composition. For this purpose, minor mixing can be provided with a Hennes-Johnson series 600 barrel mixer as well as other similar commonly available mixing equipment.

Similarly, “fire retardant” means that the adhesive in its final form, i.e. after being applied and dried, will not support combustion.

It will also be appreciated that “adhesive” is used in this disclosure in accordance with the normal meaning of this word. Solvent-based adhesives work through evaporation of the organic solvent from the composition. Nonetheless, “adhesive” is commonly used to refer to adhesive compositions both before they are applied to substrates as well as after they have been applied and an adhesive bond formed through evaporation of the solvent. That same conventional usage is followed in this disclosure as well.

The adhesive of this disclosure contains at least one water-resistant organic resin as well as at least one solvent capable of dissolving the resin. Essentially any weather-resistant organic resin capable of being dissolved in an organic solvent can be used for this purpose. In this context, “weather-resistant” means that the resin in its final form, i.e. after being formulated into an adhesive and applied to a substrate and dried, will not significantly degrade when exposed to ambient outdoor conditions including sunlight, rain, snow and the like over extended periods of time.

Examples of suitable organic resins include polybutylene, and copolymers of ethylene, propylene and butene; vinyl-based resins, e.g., polymers and copolymers of various vinyl monomers including vinyl chloride, vinylidene chloride, styrene, acrylonitrile, acrylic and methacrylic esters of all types and especially esters of C₁-C₈ alkyls; olefin-modified vinyl resins, e.g. the above vinyl polymers and copolymers further containing olefins such as ethylene, propylene, butylenes, etc.; rubber modified vinyl and olefin polymers, e.g., the foregoing polymers and copolymers further containing butadiene, isoprene or other diolefin; and the like. Mixtures of different organic resins can also be used.

Particular examples of useful organic resins include poly(methyl methacrylate) and poly(ethyl methacrylate), polystyrenes such as poly(p-styrene) and syndiotactic polystyrene, and styrene-based copolymers especially including styrene butadiene block copolymers such as SBS, SBR and SEBS, vinylic polymers such as polyvinyl chloride, polyvinylicene chloride, polyvinylidene fluoride and polyvinylidone dichloride, copolymers of ethylene, propylene and/or butylene, copolymers containing ethylene such as ethylene vinyl acetate, ethylene acrylic acid and ethylene methacrylate copolymer, and mixtures thereof. A particularly interesting class of organic resins are the styrene-modified acrylic resins, i.e. copolymers of styrene or analog (substituted styrenes substituted with one or two substituents selected from C₁-C₈ alkyls and at least one C₁-C₈ alkyl ester of acrylic acid, methacrylic acid or both. Such copolymers may contain up to 50 mol %, more typically up to 20 mol %, of one or more additional copolymerizable monomers such as the mentioned above. These copolymers are especially interesting because they form strong, coherent, weather-resistant coatings when applied in organic solution by spay coating techniques, even though they contain substantial volumes of filler materials. Moreover, they readily dissolve in inexpensive organic solvents such as mineral spirits to form storage stable adhesive compositions, even though these compositions may contain large volumes of light weight fillers.

Another advantage of the styrene-modified acrylic resins is that they can be formulated to affect the rheological properties of the adhesive composition obtained by suitable cross-linking. As indicated above, the adhesive compositions of this disclosure have a fairly low density, i.e. 6 lbs/gal or less, or even 5 lbs/gal or less. To achieve these low densities, large quantities of light weight fillers are normally included in the compositions, as further discussed below. These light weight fillers tend to separate out (float) during storage, and so it is desirable to include in the compositions suitable ingredients such as rheological agents and the like which will retard this from happening.

In accordance with one aspect of this disclosure, styrene acrylic resins which have been at least partially cross-linked can be used for this purpose. Certain commercially-available resins known as “Theological resins,” when dissolved in organic solvent, impart a significant increase in the viscosity of the solution obtained. Certain commercially-available cross-linked styrene acrylic resins such as Plioway ECT available from Eliokem of Akron, Ohio, exhibit this property. Accordingly in one embodiment of the technology disclosed here, sufficient styrene acrylic rheological resin is included in the adhesive to disperse its light weight filler and thereby enhancing storage stability.

The amount of organic resin included in the adhesives of this disclosure can vary widely. Normally, the organic resin will be present in amounts ranging from about 20 wt. % to 60 wt. %, although concentrations on the order of about 25-50 wt. %, or even 30-40 wt. % are more typical.

Where a rheological resin is included, some or all of the organic resin component of the adhesive may be composed of the rheological resin, depending on the strength of its viscosity-modifying properties and the extent of viscosity modification desired. For example, where the rheological resin has significant viscosity-altering properties as in the case of Plioway ECT, for example, a relatively small amount, e.g., 1-5 wt. %, more typically 2-4 wt. %, based on the weight of adhesive composition, will usually be needed to achieve the desired viscosity modifying effect.

In addition to an organic resin, the adhesive of this disclosure contains a solvent for this organic resin. Mineral spirits is a desirable organic solvent, since it is readily available, inexpensive, has a relatively low vapor pressure and exhibits moderate solvency, i.e. it is capable of dissolving large quantities of various types of organic resins. Other solvents which can be used include other petroleum fractions such as naphtha and the like, natural and synthetic spirits, etc.

In this connection, the adhesive of this disclosure should be VOC-compliant, meaning that it should contain no more than 250 gm/l of non-exempt volatile organic compounds. “Non-exempt” in this context means solvents which are not listed on SCAQMD, Rule 102, Groups 1&2 (As Amended Oct. 19, 2001). Therefore, the particular solvent chosen for a particular application should be selected so that it dissolves the organic resin or resins in the system while not contributing more than 250 gm/l of non-exempt volatile organic compound to the system.

Another component of the adhesive of this disclosure is the light weight filler. By “light weight filler” is meant materials which have a density no greater than about 0.5 lbs/gal gm/cc. Of particular interest are light weight fillers having densities of about 0.25 lb/gal gm/cc or less or even about 0.2 lb/gal gm/cc or less. Such materials are well known and include, for example, hollow polymer or glass microspheres, such as acrylonitrile-based hollow microspheres. Desirably, polymer-based hollow microspheres should be solvent resistant, i.e., they should not be dissolved or destroyed by the solvents used in the adhesive in which they are used.

As indicated above, the adhesive compositions of this disclosure have a density of 6 lbs./gal. or less, and in some instances 5 lbs/gal or less or even 4.0 lbs/gal or less. To accomplish this objective, these compositions contain a relatively large amount of lightweight filler on a volume basis, although on a weight basis this amount is relatively small due to their low densities. Thus, the adhesives will normally contain between about 0.5-5 wt. % light weight filler, more typically between about 1-4 or even 2-3 wt. % light weight filler. However on a volume basis, this normally translates to a concentration of about 20-60% vol %, more typically about 30-55 vol % or even 40-50 vol %, depending on the density of the particular light weight filler employed.

Various optional ingredients can also be included in the adhesives of this disclosure including pigments, pigment extenders, wetting agents, plasticizers, fire retardants, defoaming agents and other additives.

Pigments can be included in the adhesives of this disclosure to add reflectance. Since it is desirable that reflectant roof covering of this disclosure reflect as much of the sun's infrared radiation as possible, it desirable in at least one embodiment to include a white or other light-colored pigment in the adhesive. Titanium dioxide will most commonly be used for this purpose, as it is widely available and relatively inexpensive.

Any amount of pigment can be included in the adhesives of this disclosure. Normally, the amount of pigment will not exceed 15 wt. %, more typically 10 wt. %. In addition, pigments will be normally be used in amounts sufficient to achieve the color desired, which normally involves concentrations of at least about 0.5 wt. % or more, more typically about 2, 4 or even 5 wt. % or more.

Also, up to 50 wt. % of the pigment can be replaced with a pigment extender such as anhydrous calcium sulfate and calcium carbonate. Such extenders can reduce pigment costs.

Plasticizers can also be included in the adhesive for reducing viscosity, and hence enhancing sprayability, of the compositions obtained. Plasticizers also maintain polymer flexibility and hence the long term adhesion of the cool roof covering to its substrate. Certain plasticizers such as brominated and/or chlorinated paraffins, for example, also enhance fire retardancy. Any amount of plasticizer can be used, although concentrations exceeding about 15 wt. %, more typically more than about 10 wt. %, based on the weight of the adhesive composition as a whole are normally avoided.

Other conventional additives such as wetting agents, defoaming agents, UV absorbers and fire retardants can be included in conventional amounts, if desired. In this connection, combinations of calcium sulfate dihydrate and brominated and/or chlorinated paraffins, as mentioned above, provide an interesting fire-retardant package in that they can suppress combustion without adversely affecting density, viscosity, pigment loading and film formation of the adhesives in which they are contained.

Forming the New Cool Roof Covering

The new cool roof covering of this disclosure is formed in essentially the same way as the conventional asphalt/aggregate layered roofing systems described above, i.e., by applying a layer of adhesive to the roof substrate to be protected and then covering the adhesive with a layer of aggregate while the adhesive is still pliable to at least partially embed this aggregate layer in the adhesive.

Normally, the amount of adhesive applied will be sufficient to provide and adhesive layer (before application of the aggregate) of about 50 to 100 mm (millimeters) thick, more typically about 70 to 90 mm, or even 75 to 85 mm, thick. Similarly, the amount of aggregate employed will depend in large part on the type of aggregate used. Where No. 11 granules are used, for example, 60 lbs of aggregate per 100 square feed of roofing substrate is typical. In contrast, where full size gavel is used, 400-500 lbs of aggregate per 100 square feed of roofing substrate is more typical. Normally, therefore, the amount of aggregate used will typically be sufficient to provide at least about 50 lb, more typically at least about, 100 lb, 150 lb, 175 lb, or even 200 lb aggregate, per 100 square feet of a roofing application.

### EXAMPLES

In order to more thoroughly describe the present invention, the following working examples are presented:

### Example 1

### Adhesive Composition

An adhesive composition made from the ingredients listed in the following Table 1 was prepared by adding the ingredients listed in the order indicated with sufficient mixing to form a homogenous composition:

TABLE 1
Adhesive Composition No. 1

| Chemical Name/ | | |
|---|---|---|
| Group or Family | Use | Wt % |
| Mineral Spirits | Vehicle/solvent | 26.4 |
| S-100 Aromatic hydrocarbon | aromatic vehicle/solvent | 6.4 |
| Chlorinated Paraffins | Flame Retardant, | 2.0 |
| | plasticizer | |
| 2,2,4-Trimethyl-1,3- | pasticizer | 5.0 |
| Pentanediol Diisobutyrate | | |
| Styrene/Acrylate copolymer | resin | 32.2 |
| Partially Cross-Linked | Rheological Resin | 2.5 |
| Styrene Acrylate copolymer | | |
| Solution of a saturated | Wetting agent | 1 |
| polyester w/acid groups | | |
| Titanium Dioxide | Pigment | 7.1 |
| Calcium Sulfate | Pigment extender | 1.7 |
| Calcium Sulfate Dihydrate | Flame Retardant filler | 2 |
| Solution of foam destroying | defoamer | 0.5 |
| polymers | | |
| Acrylonitrile Copolymer | Light weight filler | 2.7 |
| encapsulating a blowing | | |
| agent | | |
| Mineral Spirits | Vehicle/solvent | 10.9 |
| | | 100 |

### Example 2

### Adhesive Composition

Example 1 was repeated, except the adhesive was prepared from the ingredients listed in the following Table 2:

TABLE 2
Adhesive Composition No. 2

| Chemical Name/ | | | |
|---|---|---|---|
| Group or Family | Use | Wt % | Vol % |
| Mineral Spirits | Vehicle/solvent | 32.4 | 20.9 |
| S-100 Aromatic hydrocarbon | aromatic vehicle/ | 9.7 | 5.6 |
| | solvent | | |
| Alkenes C12-C30. | Flame Retardant, | 2.2 | 0.7 |
| Alpha.-bromo chloro | plasticizer | | |
| 2,2,4-Trimethyl-1,3- | pasticizer | 7.6 | 4 |
| Pentanediol Diisobutyrate | | | |
| hydroxyphenylbenzotriazole | UV Absorber | 0.3 | 0.1 |
| class | | | |
| hindered amine | light stabilizer | 0.3 | 0.18 |
| Styrene/Acrylate | resin | 25.5 | 12 |
| copolymer | | | |
| Substituted Styrene | Rheological Resin | 1.9 | 0.9 |
| Acrylate copolymer | | | |
| Solution of a saturated | Wetting agent | 1.1 | 0.53 |
| polyester w/acid groups | | | |
| Titanium Dioxide | Pigment | 9.1 | 1.1 |
| Calcium Sulfate | Pigment extender | 4.5 | 0.44 |
| Calcium Sulfate | Flame Retardant | 2.2 | 0.75 |
| Dihydrate | filler | | |
| Solution of foam | defoamer | 0.5 | 0.3 |
| destroying polymers | | | |
| Acrylonitrile Copolymer | Light weight | 2.7 | 51.7 |
| encapsulating a blowing agent | filler | | |
| | | 100 | 100 |

### Example 3

### Forming a Cool Roof Covering

A cool roof covering made in accordance with this disclosure was formed on a roof substrate comprising of a BUR (built up roof) or MB (Modified Bitumen) system composed of multiple layers of bituminous coated membranes adhered to form a monolithic membrane upon fully curing. This was done by spraying Adhesive No. 2 as described in Example 2 above onto the roof substrate using a 4000 psi commercial spray unit with an external heat exchange unit to form an adhesive layer 80 mil or 0.080 inch or 2 mm thick. Immediately thereafter, and before the adhesive had a chance to dry, an aggregate layer composed of white granite aggregate having an average diameter of about ⅜″ was applied to the adhesive in an amount of 200 lbs per 100 square feet. Approximately ⅔ of the aggregate embedded itself in the wet adhesive through the action of gravity.

Within a few hours of application, the cool roof covering so applied was weather resistant. After 30 days, the adhesive had totally dried (i.e., essentially all the mineral spirits had evaporated) thereby producing a weather resistant cool roof according with this disclosure having a solar reflectance of greater than 70%, as measured by ASTM E1918-97 or ASTM E903-96 and a thermal emittance of greater than 75%, as measured by ASTM E-408-71.

Although only a few embodiments of the new cool roof covering of this disclosure have been provided above, many modifications can be made without departing from the spirit and scope of this disclosure. All such modifications are intended to be included within the scope of the technology disclosed here, which is to be limited only by the following claims.

1. An adhesive for use in forming a cool roof covering, the adhesive comprising a storage-stable, VOC-compliant, sprayable mixture containing one or more weather-resistant organic resins, an organic solvent system capable of dissolving the organic resins and a light weight filler present in sufficient amount so that the adhesive has a density of 6 lbs./gal. or less.

2. The adhesive of claim 1, wherein the adhesive has a density of 5 lbs./gal. or less.

3. The adhesive of claim 1, wherein the adhesive contains about 20-60 wt. % weather-resistant organic resin and about 0.5-5 wt. % of a light weight filler having a density of no greater than about 5 lb/gal.

4. The adhesive of claim 3, wherein the adhesive contains about 20-60% vol % light weight filler.

5. The adhesive of claim 4, wherein the adhesive contains a rheological resin.

6. The adhesive of claim 4, wherein the adhesive contains about 0.5-15 wt. % pigment.

7. The adhesive of claim 4, wherein the adhesive contains about 25-50 wt. % of a styrene-modified acrylic resin comprising a copolymer of (1) styrene or a substituted styrene substituted with one or two substituents selected from C₁-C₈ alkyls and (2) at least one C₁-C₈ alkyl ester of acrylic acid, methacrylic acid or both, the copolymer optionally containing no more than 50 mol % of an additional copolymerizable monomer.

8. The adhesive of claim 7, wherein the adhesive contains at least two different styrene-modified acrylic resins, at least one of these styrene-modified acrylic resins being cross-linked.

9. The adhesive of claim 3, wherein the solvent in the adhesive comprises mineral spirits.

10. The adhesive of claim 3, wherein the adhesive is fire retardant.

11. The adhesive of claim 3, wherein the adhesive contains a fire retardant comprising at least one of calcium sulfate dihydrate and chlorinated or brominated paraffins.

12. The adhesive of claim 12, wherein the fire retardant contains both calcium sulfate dihydrate and a chlorinated or brominated paraffin.

13. A cool roof covering on a roof substrate, the cool roof covering comprising an adhesive layer and a layer of aggregate at least partially embedded in the adhesive layer, the cool roof covering exhibiting a solar reflectance of at least 75% and a thermal emittance of at least 70%, the adhesive layer being formed from a VOC-compliant organic solvent-based sprayable adhesive.

14. The cool roof covering of claim 13, wherein the aggregate is limestone, marble or both.

15. The cool roof covering of claim 13, wherein the adhesive layer is formed from an adhesive comprising a storage-stable, VOC-compliant, sprayable mixture containing one or more weather-resistant organic resins, an organic solvent system capable of dissolving the organic resins and a light weight filler present in sufficient amount so that the adhesive has a density of 6 lbs./gal. or less.

16. The cool roof covering of claim 3, wherein the adhesive has a density of 5 lbs./gal. or less.
